(19) United States
(12) Patent Application Publication
(10) Pub. No.: US 2017/0341952 A1
(43) Pub. Date: Nov. 30, 2017

(54) CHEMICAL EXTRACTION FROM AN AQUEOUS SOLUTION AND POWER GENERATOR COOLING

(71) Applicant: X Development LLC, Mountain View, CA (US)

(72) Inventor: Matthew D. Eisaman, Port Jefferson, NY (US)

(21) Appl. No.: 15/165,205

(22) Filed: May 26, 2016

(51) Int. Cl. C02F 1/20; C02F 1/52; C02F 1/469; C02F 103/02; C02F 103/08

(52) U.S. Cl. CPC C02F 1/20; C02F 1/5236; C02F 1/4693; C02F 2103/08; C02F 2103/023

(57) ABSTRACT

A method of chemical extraction and power generator cooling includes receiving an aqueous solution with dissolved inorganic carbon. The method further includes extracting the dissolved inorganic carbon from the aqueous solution and collecting the dissolved inorganic carbon. The aqueous solution is then acidified and supplied to the power generator to cool the power generator.

### TECHNICAL FIELD

This disclosure relates generally to chemical extraction.

### BACKGROUND INFORMATION

Pure carbon dioxide (CO₂) has many industrial uses. The separation of CO₂ from a mixed-gas source may be accomplished by a capture and regeneration process. The process generally includes a selective capture of CO₂, accomplished by, for example, contacting a mixed-gas source with a solid or liquid adsorber/absorber followed by a generation or desorption of CO₂ from the adsorber/absorber. One technique describes the use of bipolar membrane electrodialysis for CO₂ extraction/removal from potassium carbonate and bicarbonate solutions.

For capture/regeneration systems, a total volume of mixed-gas source that must be processed is generally inversely related to a concentration of CO₂ in the mixed-gas source, adding significant challenges to the separation of CO₂ from dilute sources such as the atmosphere. CO₂ in the atmosphere, however, establishes equilibrium with the total dissolved inorganic carbon in the oceans, which is largely in the form of bicarbonate ions (HCO₃—) at an ocean pH of 8.1-8.3. Therefore, a method for extracting CO₂ from the dissolved inorganic carbon of the oceans would effectively enable the separation of CO₂ from atmosphere without the need to process large volumes of air.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified. The drawings are not necessarily to scale, emphasis instead being placed upon illustrating the principles being described.

FIG. 1A is an illustration of a system for chemical extraction from an aqueous solution and power generator cooling, in accordance with an embodiment of the disclosure.

FIG. 1B is an illustration of a system for chemical extraction from an aqueous solution and power generator cooling, in accordance with an embodiment of the disclosure.

FIG. 1C is an illustration of a system for chemical extraction from an aqueous solution and power generator cooling, in accordance with an embodiment of the disclosure.

FIG. 2 is an example electrodialysis unit, in accordance with an embodiment of the disclosure.

FIG. 3 is an illustration of a method for chemical extraction from an aqueous solution and power generator cooling, in accordance with an embodiment of the disclosure.

### DETAILED DESCRIPTION

Embodiments of an apparatus and method for chemical extraction from an aqueous solution and power generator cooling are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Throughout the specification and claims, compounds/elements are referred to both by their chemical name (e.g., carbon dioxide) and chemical symbol (e.g., CO₂). It is appreciated that both chemical names and symbols may be used interchangeably and have the same meaning.

This disclosure provides for the removal of carbon from water sources containing dissolved inorganic carbon (e.g., bicarbonate ions HCO₃—) while simultaneously cooling power generators/power plants. The world's oceans act as carbon sinks absorbing large quantities of atmospheric carbon. As will be shown, systems and methods in accordance with the teachings of the present disclosure may be used to remove dissolved inorganic carbon from the water and convert it into other useful materials, while also cooling a power plant. The pH and alkalinity of the water is then adjusted prior to returning the water to the ocean to ensure that, once the water is return to the ocean, additional CO₂ is absorbed from the atmosphere and the water reestablishes equilibrium with the atmosphere. The chemical removal systems and the power plant have a synergistic relationship: the chemical systems prevent scaling in the power plant, while the power plant provides energy and infrastructure for the chemical systems. Furthermore, removing excess carbon from the oceans may be both lucrative and environmentally restorative.

Many thermoelectric power plants use seawater for cooling. Some power plants use an open—or once-through—cycle in which the seawater passes through the plant only once. Other power plants use closed cycle cooling, in which about 5% of water is evaporated during cooling, and the residual hot water is passed to a condenser for an additional cooling cycle. In the once-through case, the concentration of salts in the seawater remains roughly the same as in the input seawater; however, in a closed cycle system addition of make-up water and blowdown of concentrated water is required. The blowdown often has about twice the concentration of ions as the original seawater.

Environmental considerations are making closed cycle systems increasingly common. In closed cycle cooling, the high concentration of ions in the seawater further increases efficiency of the proposed chemical extraction systems, thus reducing the cost of the carbon extraction process.

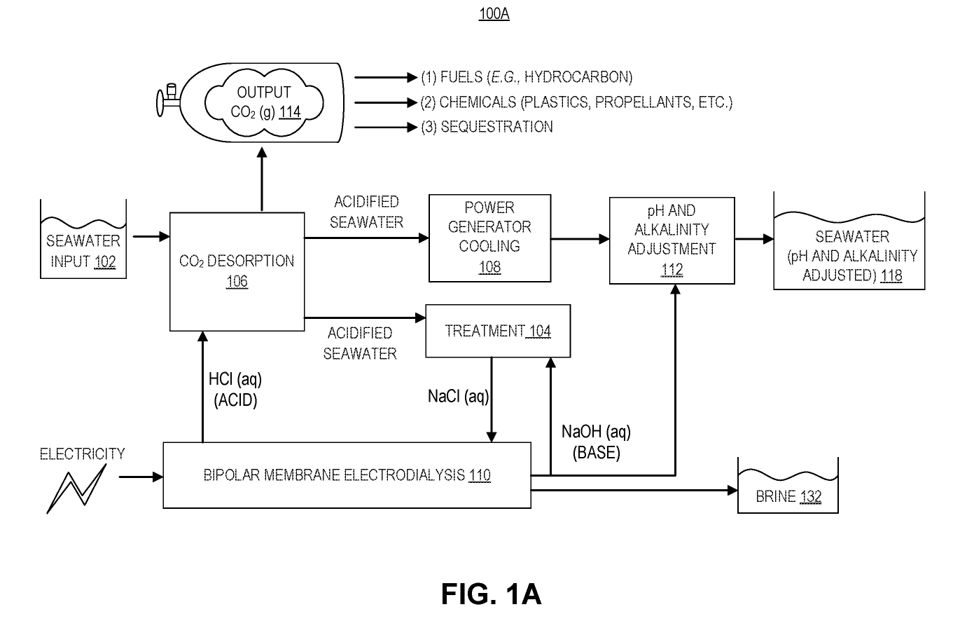

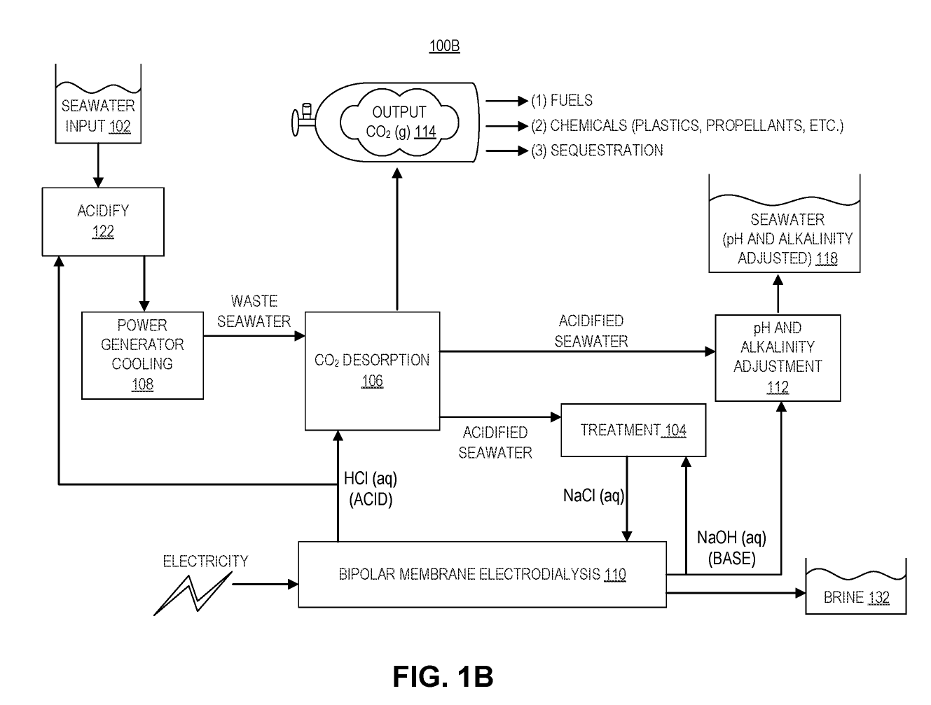

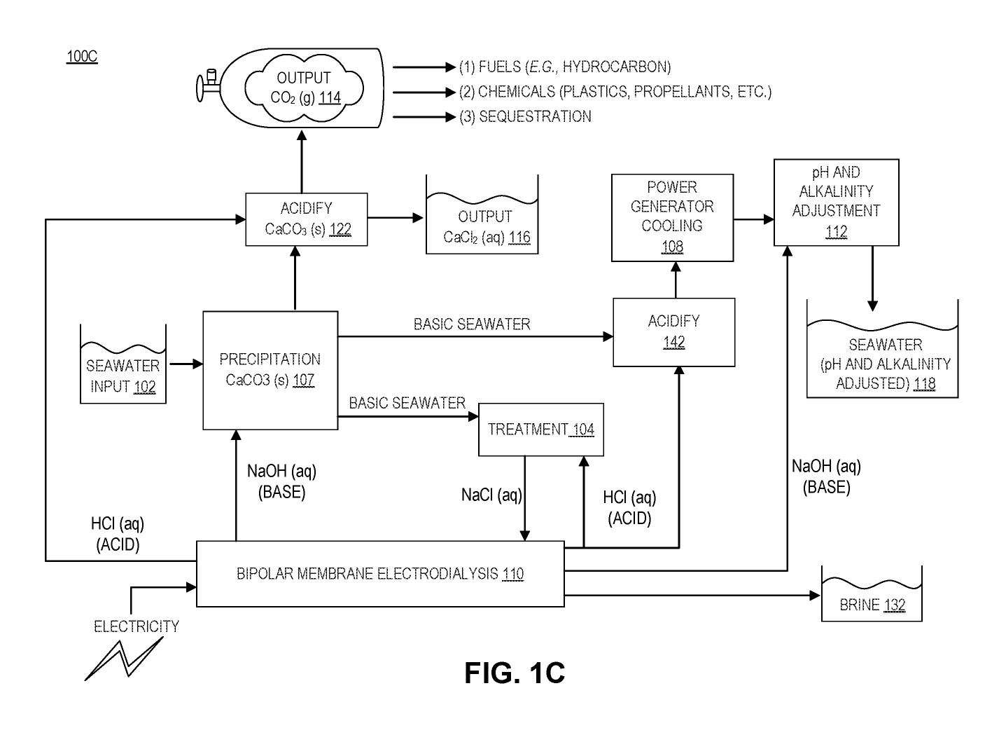

FIG. 1A is an illustration of system 100A for chemical extraction from an aqueous solution and power generator cooling, in accordance with an embodiment of the disclosure. System 100A includes: input 102 (to input an aqueous solution containing dissolved inorganic carbon), treatment unit 104, carbon desorption unit 106, power generator cooling unit 108, electrodialysis unit 110, pH and alkalinity adjustment unit 112, CO₂ gas collection unit 114, water output 118, and brine output 132.

As shown, input 102 is coupled to a water reservoir containing dissolved inorganic carbon (e.g., bicarbonate ions). The water reservoir may be an ocean, lake, river, manmade reservoir, or brine outflow from a reverse osmosis (“RO”) process. Input 102 may receive the water through a system of channels, pipes, and/or pumps depending on the specific design of the facility/system. In one embodiment, input 102 may already be a preexisting portion of a power plant. One skilled in the art will appreciate that large aggregate may be removed from the water at any time during intake.

The aqueous solution is then flowed into carbon desorption unit 106. Carbon desorption unit 106 is coupled to receive the aqueous solution including dissolved inorganic carbon (e.g., seawater) and aqueous HCl from electrodialysis unit 110. In response to receiving the aqueous HCl and the aqueous solution, carbon desorption unit 106 outputs CO₂ and the aqueous solution. In one embodiment, carbon desorption unit 106 vacuum strips CO₂ gas from the acidified aqueous solution. However, membrane degasification or deaerator systems may be used. In one embodiment, to facilitate desorption of CO₂, the input seawater is acidified (to a pH in the range 4-6).

In system 100A, carbon desorption unit 106 is coupled to gas collection unit 114 to collect the CO₂. Gas collection unit 114 may include one or more compressors (and/or gas purifiers) to contain evolved CO₂ in compressed gas cylinders. It is appreciated that concentrated CO₂ has many industrial uses including, but not limited to: a chemical precursor (e.g., for creating biofuels—by feeding the CO₂ to algae; for creating hydrocarbon fuels via hydrogenation of the CO₂ to methanol—by feeding the CO₂ along with steam into a solid oxide electrolysis cell to make syngas and subsequently using Fischer Tropsch reactions to make liquid hydrocarbons), as a food additive (e.g., drink carbonation), as an inert gas, etc. CO₂ extracted by the process disclosed here may be used in any of these applications and others not listed.

As shown, carbon desorption unit 106 includes a receptacle configured to couple to a power generator cooling unit 108 so the aqueous solution flows through both carbon desorption unit 106 and power generator cooling unit 108. In the depicted embodiment, water flows into carbon desorption unit 106 before flowing though the power generator. In other words, aqueous solution flows from the carbon desorption unit 106 to the power generator cooling unit 108.

In the depicted embodiment, power generator cooling unit 108 is directly coupled to carbon desorption unit 106 to receive the acidified seawater from the carbon desorption unit 106. The low pH (4-6) of this cooling water prevents scaling on the interior of the power generator cooling unit 108, and eliminates the need for the power generator to employ other scale prevention techniques. In one embodiment, the power generator is a thermoelectric power plant.

As shown, once the acidified water has been used to cool the power generator/power plant, the water is flowed to pH and alkalinity adjustment unit 112. The pH and alkalinity adjustment unit 112 is coupled to electrodialysis unit 110 to receive HCl and NaOH, and adjust a pH and alkalinity of the wastewater to a pH of seawater (or other environmentally safe pH value). In one embodiment, the pH and alkalinity of wastewater flowed into pH and alkalinity adjustment unit 112 is monitored in real time, and HCl or NaOH is flowed into pH and alkalinity adjustment unit 112 in response to the real time measurements. Adjusting the pH of wastewater flowing from system 100A ensures minimal environmental impact of running system 100A, while adjusting the alkalinity ensures sufficient reabsorption of atmospheric CO₂ once the water is returned to the ocean.

In the illustrated embodiment, a portion of the water received by carbon desorption unit 106 is diverted into treatment unit 104. Additionally, treatment unit 104 is coupled to receive NaOH from electrodialysis unit 110 to aid in the precipitation of divalent cations (Ca²⁺ and Mg²⁺, for example) from the water input to treatment unit 104. Treatment unit 104 outputs a relatively pure stream of aqueous NaCl. In other words, an aqueous solution (possibly including seawater) is input to treatment unit 104, and aqueous NaCl is output from treatment unit 104. Treatment unit 104 may be used to remove organic compounds and other minerals (other than NaCl) not needed in, or harmful to, subsequent processing steps. For example, removal of chemicals in the water may mitigate scale buildup in electrodialysis unit 110. Treatment unit 104 may include filtering systems such as: nanofilters, RO units, ion exchange resins, precipitation units, microfilters, screen filters, disk filters, media filters, sand filters, cloth filters, and biological filters (such as algae scrubbers), or the like. Additionally, treatment unit 104 may include chemical filters to removed dissolved minerals/ions. One skilled in the art will appreciate that any number of screening and/or filtering methods may be used by treatment unit 104 to remove materials, chemicals, aggregate, biologicals, or the like.

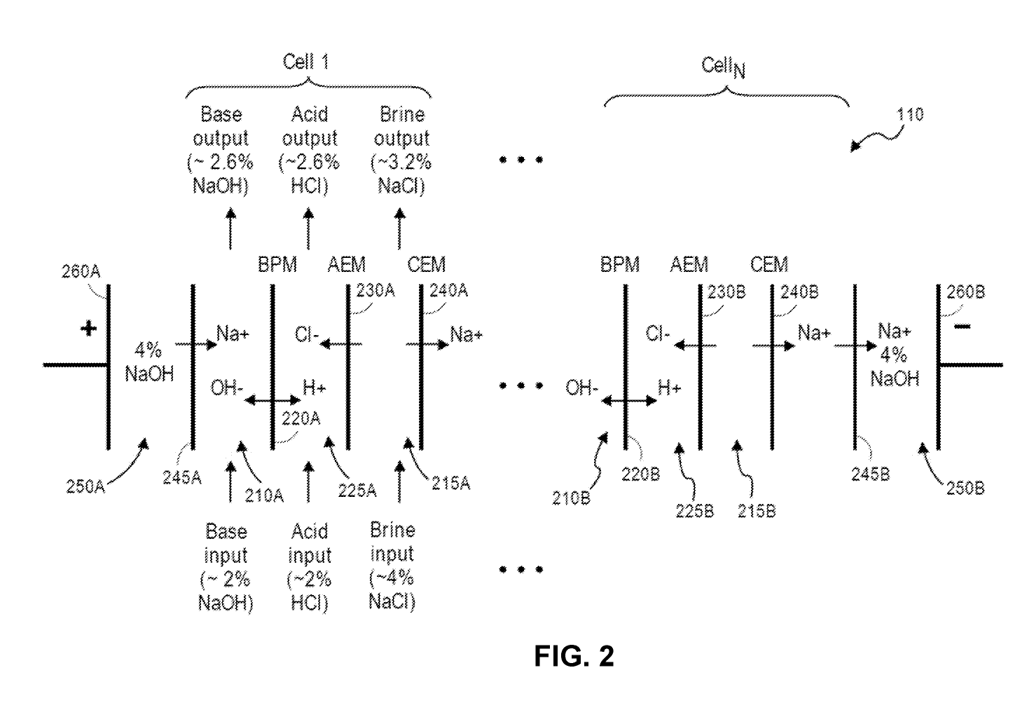

Electrodialysis unit 110 is coupled to receive aqueous NaCl (from treatment unit 104) and electricity, and output aqueous HCl, aqueous NaOH, and brine (to brine output 132). Aqueous HCl and aqueous NaOH output from electrodialysis unit 110 may be used to drive chemical reactions in system 100A. The specific design and internal geometry of electrodialysis unit 110 is discussed in greater detail in connection with FIG. 2 (see infra FIG. 2). Brine output from electrodialysis unit 110 may be used in any applicable portion of system 100A. For example, brine may be cycled back into electrodialysis unit 110 as a source of aqueous NaCl, or may be simply expelled from system 100A as wastewater.

FIG. 1B is an illustration of a system 100B for chemical extraction from an aqueous solution and power generator cooling, in accordance with an embodiment of the disclosure. System 100B is similar in many respects to system 100A of FIG. 1A. However, one difference is that carbon desorption in system 100B occurs after power generator cooling (not before, as in system 100A). Accordingly, system 100B also includes an acidification unit 122 coupled to receive incoming seawater and output acidified seawater to power generator cooling unit 108 (to prevent scale buildup on the inside of the power generator/power plant).

In system 100B input seawater is slightly acidified in acidification unit 122 (to a pH range of 6-7). The acidified seawater is then fed into power generator cooling unit 108. After the acidified water has been used to cool the power generator, the water is transferred to carbon desorption unit 106 where the pH of the acidic seawater is further decreased to a pH range of 4-5 and the seawater is decarbonized. Once the CO₂ gas is extracted, the acidified water is transferred to pH and alkalinity adjustment unit 112. In pH and alkalinity adjustment unit 112 the pH and alkalinity of the water is increased by the addition of NaOH. The water is adjusted to its original alkalinity so when the water is returned to the ocean the water will absorb an amount of CO₂ from the air equal to the amount of CO₂ extracted. Wastewater is then expelled from system 100B via water output 118.

As in system 100A of FIG. 1, system 100B uses electrodialysis unit 110 to generate the acids and bases employed in system 100B. Electrodialysis unit 110 supplies HCl to acidification unit 122 (to acidify the water prior to power plant cooling), and to carbon desorption unit 106 (to further acidify the water for CO₂ desorption). Electrodialysis unit 110 supplies NaOH to treatment unit 104 to aid in the precipitation of divalent cations (Ca²⁺ and Mg²⁺, for example) from carbon desorption unit 106 (for use in the electrodialysis process). NaOH is also supplied by electrodialysis unit 110 to pH and alkalinity adjustment unit 112 to restore the pH and alkalinity of wastewater to an environmentally safe level.

FIG. 1C is an illustration of system 100C for chemical extraction from an aqueous solution and power generator cooling, in accordance with an embodiment of the disclosure. System 100C is similar in many respects to systems 100A & 100B of FIGS. 1A & 1B. However, one difference is system 100C extracts carbon via basic precipitation of calcium salts (rather than acidic desorption of CO₂ gas as in FIGs. lA & 1B). Accordingly, system 100C has several additional components, namely: precipitation unit 107, first acidification unit 122, second acidification unit 142, and CaCl ouput 116.

In system 100C, precipitation unit 107 has a first input coupled to receive an aqueous solution including dissolved inorganic carbon (e.g., seawater) from input 102. Precipitation unit 107 also has a second input coupled to electrodialysis unit 110 to receive aqueous NaOH. In response to receiving the aqueous solution and the aqueous NaOH, precipitation unit 107 precipitates calcium salts (for example, but not limited to, CaCO₃) and outputs the aqueous solution. However, in other embodiments, other chemical processes may be used to basify the aqueous solution in precipitation unit 107. For example, other bases (not derived from the input aqueous solution) may be added to the aqueous solution to precipitate calcium salts.

In one embodiment, NaOH is added to incoming seawater until the pH is sufficiently high to allow precipitation of calcium salts without significant precipitation of Mg(OH)₂. The exact pH when precipitation of CaCO₃ occurs (without significant precipitation of Mg(OH)₂) will depend on the properties of the incoming seawater (alkalinity, temperature, composition, etc.); however, a pH of 9.3 is typical of seawater at a temperature of 25° C. In a different embodiment, the quantity of NaOH added is sufficient to precipitate CaCO₃ and Mg(OH)₂, then the pH is lowered (e.g., by adding HCl from electrodialysis unit 110 until the pH is <9.3) so that the Mg(OH)₂ (but not CaCO₃) redissolves.

In one embodiment, precipitation unit 107 may be a large vat or tank. In other embodiments, precipitation unit 107 may include a series of ponds/pools. In this embodiment, precipitation of calcium salts may occur via evaporation driven concentration (for example using solar ponds) rather than, or in combination with, adding basic substances. Precipitation unit 107 may contain internal structures with a high surface area to promote nucleation of CaCO₃; these high surface area structures may be removed from precipitation unit 107 to collect nucleated CaCO₃. Precipitation unit 107 may include an interior with CaCO₃ to increase nucleation kinetics by supplying seed crystals. The bottom of precipitation unit 107 may be designed to continually collect and extract precipitate to prevent large quantities of scale buildup.

In another or the same embodiment, heat may be used to aid precipitation. For example solar ponds may be used to heat basified water. In continuously flowing systems, low temperature waste heat solution may be flowed through heat exchange tubes with basified seawater on the outside of the tubes. Alternatively, heating the bottom of precipitation unit 107 may be used to speed up precipitation.

After CaCO₃ is precipitated from the water, CaCO₃ may be buried or incorporated into building materials in order to sequester the CO₂ contained therein, or optionally the CaCO3 may be transferred to first acidification unit 122. In the depicted embodiment, first acidification unit 122 is coupled to receive CaCO₃ from precipitation unit 107 and coupled to receive aqueous HCl from electrodialysis unit 110. In response to receiving CaCO₃ and aqueous HCl, first acidification unit 122 produces CO₂. In the depicted embodiment, first acidification unit 122 is used to evolve CaCO₃ into CO₂ gas and aqueous CaCl₂ according to the following reaction: CaCO₃ (s) 2HCl (aq)→CaCl₂ (aq)+H₂0 (1) +CO₂ (). Reaction kinetics may be increased by agitating/heating the acidified mixture. By adding HCl to CaCO₃, CO₂ is spontaneously released due to the high equilibrium partial pressure of CO₂ gas. This may eliminate the need for membrane contactors or vacuum systems.

Once all CO₂has been extracted from acidification unit 122, wastewater containing CaCl₂ is output from system 100C via CaCl₂ output 116. In one embodiment, the wastewater is returned to the ocean or other water source after the pH of the wastewater has been adjusted. In other embodiments, the wastewater maybe contained and further processed to remove other minerals.

Once carbon has been extracted, basic seawater from precipitation unit 107 is sent to second acidification unit 142 where it is acidified to a pH of 6-7. The acidified seawater is then fed to power generator cooling unit 108. The low pH of the cooling water prevents scaling and eliminates the need for the power generator/power plant to employ other scale prevention techniques. When finished cooling the power generator, the pH of the waste acidic seawater is increased in pH and alkalinity adjustment unit 112 (by adding NaOH) to return the water to its original alkalinity. Thus when the water is returned to the ocean it will absorb an amount of CO₂ from the air equal to the amount of CO₂ extracted.

In the depicted embodiment, all acids and bases are supplied by electrodialysis unit 110. For example, electrodialysis unit 110 supplies HCl to first acidification unit 122 (to extract CO₂ gas from the calcium salts), second acidification unit 142 (to reduce the pH of the seawater for power plant cooling), and treatment unit 104 (to neutralize the aqueous NaCl for use by electrodialysis unit 110). Similarly, electrodialysis unit 110 supplies NaOH to precipitation unit 107 (to precipitate calcium salts), and to pH and alkalinity adjustment unit 112 (to restore the pH and alkalinity to environmentally safe levels).

One skilled in the art will appreciate that while system 100C converts the calcium salts into CO₂ gas, the precipitated calcium salts may be used as a raw material output. It is appreciated that CaCO₃ has many industrial uses including (but not limited to): building materials (e.g., limestone aggregate for road building, an ingredient of cement, starting material for the preparation of builder's lime, etc.), dietary supplements (e.g., calcium supplement or gastric antacid), soil neutralizers, and the like. Calcium salts from the process shown in FIG. 1C may be used for any of these purposes and others not discussed such as sequestration of carbon by burying the CaCO₃.

Further in other embodiments, system 100C may include a second precipitation unit with a first input coupled to receive the aqueous solution (e.g., seawater) from precipitation unit 107, and a second input coupled to electrodialysis unit 110 to receive aqueous NaOH. In response to receiving the aqueous solution and the aqueous NaOH, the second precipitation unit may precipitate magnesium salts (for example, but not limited to, Mg(OH)₂) and output the aqueous solution. In other words, after precipitating the CaCO₃, the pH of the water may be adjusted to a second pH threshold where Mg(OH)₂ precipitates (e.g., a pH of 10.4). Like precipitation unit 107, the second precipitation unit can use any number of structures/techniques to speed up nucleation kinetics of Mg(OH)₂. For example, the second precipitation unit may include high surface area inserts, Mg(OH)₂ seed crystals, or may be heated/cooled to promote nucleation of Mg(OH)₂. The Mg(OH)₂ may be used in its natural state (e.g., medical applications such as to neutralize stomach acid), or may be converted into pure Mg and/or other compounds, depending on the desired use case.

Systems 100A-100C may be coupled to, and run by, electronic control systems. Regulation and monitoring may be accomplished by a number of sensors throughout the system that either send signals to a controller or are queried by controller. For example, with reference to electrodialysis unit 110, monitors may include one or more pH gauges to monitor a pH within the units as well as pressure sensors to monitor a pressure among the compartments in electrodialysis unit 110 (to avoid inadvertent mechanical damage to electrodialysis unit 110). Another monitor may be a pH gauge placed within precipitation unit 107 to monitor a pH within the tank. The signals from such pH monitor or monitors allows a controller to control a flow of brine solution (from input 102) and a basified solution (from electrodialysis unit 110) to maintain a pH value of a combined solution that will result in a precipitation of CaCO₃.

Alternatively, systems 100A-100C may be controlled manually. For example, a worker may open and close valves to control the various water, acid, and base flows in systems 100A-100C. Additionally, a worker may remove precipitated calcium salts from precipitation unit 107. However, one skilled in the relevant art will appreciate that systems 100A-100C may be controlled by a combination of manual labor and mechanical automation, in accordance with the teachings of the present disclosure.

FIG. 2 is an example electrodialysis unit 110 (see e.g., FIGS. 1A-1C), in accordance with an embodiment of the disclosure. Electrodialysis unit 110 may be used to convert seawater (or other NaCl-containing aqueous solutions) into NaOH and HCL. As shown, in FIGS. 1A-1C, NaOH and HCl may be used to adjust the pH of the aqueous solution to precipitate calcium and magnesium salts.

In the depicted embodiment, electrodialysis unit 110 representatively consists of several cells in series, with each cell including a basified solution compartment (compartments 210A and 210B illustrated); an acidified solution compartment (compartments 225A and 225B illustrated); and a brine solution compartment (compartments 215A and 215B). FIG. 2 also shows a bipolar membrane (BPM) between a basified solution compartment and an acidified solution compartment (BPM 220A and 220B illustrated). A suitable BPM is a Neosepta BP-1E, commercially available from Ameridia Corp. Also depicted are anion exchange membranes (AEM), such as Neosepta ACS (commercially available from Ameridia Corp.), disposed between a brine compartment and an acidified solution compartment (AEM 230A and 230B illustrated). A cation exchange membrane (CEM) such as Neosepta CMX-S (commercially available from Ameridia Corp.), is disposed adjacent to a brine compartment (CEM 240A and CEM 240B illustrated). Finally, FIG. 2 shows end cap membranes 245A and 245B (such as Nafion® membranes) that separate the membrane stack from electrode solution compartment 250A and electrode solution compartment 250B, respectively.

Broadly speaking, under an applied voltage provided to electrodialysis unit 110, water dissociation inside the BPM (and the ion-selective membranes comprising a BPM) will result in the transport of hydrogen ions (H+) from one side of the BPM, and hydroxyl ions (OH-) from the opposite side. AEMs/CEMs, as their names suggest, allow the transport of negatively/positively charged ions through the membrane. The properties of these membranes such as electrical resistance, burst strength, and thickness are provided by the manufacturer (e.g., Neosepta ACS and CMX-S are monovalent-anion and monovalent-cation permselective membranes, respectively). In one embodiment, electrodialysis unit 110 includes electrodes 260A and 260B of, for example, nickel manufactured by De Nora Tech Inc. FIG. 2 also shows electrode solution compartment 250A and electrode solution compartment 250B through which, in one embodiment, a NaOH(aq) solution is flowed. Where electrode 260A is a positively-charged electrode, sodium ions (Na+) will be encouraged to move across cap membrane 245A and where electrode 260B is negatively-charged, sodium ions will be attracted to electrode solution compartment 250B. In one embodiment, the solution compartments between adjacent membranes are filled with polyethylene mesh spacers (e.g., 762 μm thick polyethylene mesh spacers), and these compartments are sealed against leaks using axial pressure and 794 mm thick EPDM rubber gaskets.

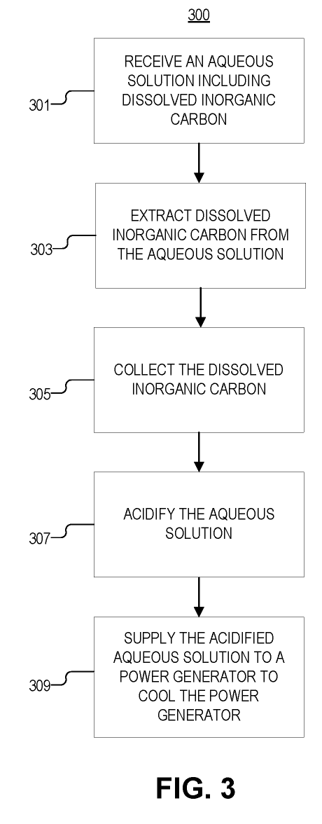

FIG. 3 is an illustration of a method 300 for chemical extraction from an aqueous solution and power generator cooling, in accordance with an embodiment of the disclosure. The order in which some or all of process blocks 301-309 appear in method 300 should not be deemed limiting. Rather, one of ordinary skill in the art having the benefit of the present disclosure will understand that some of method 300 may be executed in a variety of orders not illustrated, or even in parallel. Additionally, method 300 may include additional blocks or have fewer blocks than shown, in accordance with the teachings of the present disclosure.

Block 301 shows receiving an aqueous solution including dissolved inorganic carbon. As stated above the aqueous solution may include seawater, and the input may be the input system for a power plant or power generator. One skilled in the art will appreciate that a power generator is inclusive of power plants, systems on ships (such as nuclear reactors on aircraft carriers and submarines), or the like.

Block 303 illustrates extracting dissolved inorganic carbon from the aqueous solution. Extracting carbon may be achieved a number of different ways including, but not limited to, acidifying the aqueous solution to desorb CO₂ from the aqueous solution, and/or basifying the aqueous solution to precipitate calcium salts from the aqueous solution. In one embodiment, HCl or NaOH is used as the acid/base and the acid/base is supplied from an electrodialysis unit.

Block 305 depicts collecting the dissolved inorganic carbon. Collecting carbon may be achieved by capture of CO₂ gas via desorbing the CO₂ from acidified seawater. Alternatively, carbon may be collected by basifying the seawater and acquiring carbon-containing salts that precipitate from solution. These salts may be subsequently evolved to produce CO₂ gas (if desired).

Block 307 shows acidifying the aqueous solution. Prior to feeding the water to a power generator it may be advantageous to acidify the seawater to prevent scale buildup on the interior of the power generator. Accordingly, the water may be acidified to a pH range of 6-7.

Block 309 depicts supplying the acidified aqueous solution to the power generator to cool the power generator. Although not depicted, after feeding the water to the power plant, the pH and alkalinity of the wastewater may be adjusted so the wastewater can be safely returned to the ocean or other reservoir.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A method of chemical extraction and power generator cooling, comprising:
receiving an aqueous solution including dissolved inorganic carbon;
extracting dissolved inorganic carbon from the aqueous solution;
collecting the dissolved inorganic carbon;
acidifying the aqueous solution; and
supplying the acidified aqueous solution to the power generator to cool the power generator.

2. The method of claim 1, wherein extracting the dissolved inorganic carbon includes acidifying the aqueous solution to desorb CO₂ from the aqueous solution, and wherein the aqueous solution includes seawater.

3. The method of claim 2, wherein acidifying the aqueous solution includes adding aqueous HCl to the aqueous solution, wherein the aqueous HCl is supplied by an electrodialysis unit.

4. The method of claim 3, wherein the CO₂ is desorbed from the aqueous solution before supplying the acidified aqueous solution to the power generator.

5. The method of claim 3, wherein the CO₂ is desorbed from the aqueous solution after supplying the acidified aqueous solution to the power generator.

6. The method of claim 1, wherein extracting the dissolved inorganic carbon includes basifying the aqueous solution to precipitate calcium salts from the aqueous solution, wherein the aqueous solution includes seawater.

7. The method of claim 6, wherein basifying the aqueous solution includes adding aqueous NaOH to the aqueous solution, wherein the aqueous NaOH is supplied by an electrodialysis unit.

8. The method of claim 7, wherein acidifying the aqueous solution includes adding aqueous HCl to the aqueous solution, wherein the aqueous HCl is supplied by an electrodialysis unit.

9. The method of claim 8, wherein collecting the dissolved inorganic carbon includes evolving CO₂ from the calcium salts by applying the aqueous HCl to the calcium salts, and collecting the CO₂.

10. The method of claim 1, further comprising adjusting a pH and alkalinity of the acidified aqueous solution after supplying the acidified aqueous solution to the power generator.

11. The method of claim 1, wherein the power generator is included in a power plant.

12. A system of chemical extraction from an aqueous solution, comprising:
an electrodialysis unit coupled to receive aqueous NaCl and coupled to output aqueous HCl and aqueous NaOH; and
a carbon desorption unit coupled to receive an aqueous solution including dissolved inorganic carbon and the aqueous HCl from the electrodialysis unit, wherein in response to receiving the aqueous HCl and the aqueous solution, the carbon desorption unit outputs CO₂ and the aqueous solution, and wherein the carbon desorption unit includes a receptacle to couple to a power generator so the aqueous solution flows through the carbon desorption unit and the power generator.

13. The system of claim 12, wherein the aqueous solution includes seawater, and wherein the receptacle couples to the power generator so the aqueous solution flows through the carbon desorption unit before flowing though the power generator.

14. The system of claim 12, wherein the aqueous solution includes seawater, and wherein the receptacle couples to the power generator so the aqueous solution flows through the carbon desorption unit after flowing though the power generator.

15. The system of claim 12, wherein the system is configured to acidify the aqueous solution prior to the aqueous solution flowing through the power generator.

16. The system of claim 12, wherein the electrodialysis unit is coupled to adjust a pH and alkalinity of the aqueous solution with the aqueous NaOH after the carbon desorption unit outputs the CO₂.

17. A system of chemical extraction from an aqueous solution, comprising:
an electrodialysis unit coupled to receive aqueous NaCl and coupled to output aqueous HCl and aqueous NaOH; and
a precipitation unit coupled to receive an aqueous solution including dissolved inorganic carbon and the aqueous NaOH from the electrodialysis unit, wherein in response to receiving the aqueous NaOH and the aqueous solution, the precipitation unit outputs calcium salts and the aqueous solution, and wherein the precipitation unit includes a receptacle to couple to a power generator so the aqueous solution flows through the precipitation unit and the power generator.

18. The system of claim 17, further comprising a first acidification unit coupled to receive the aqueous HCl from the electrodialysis unit and the calcium salts from the precipitation unit, wherein in response to receiving the aqueous HCl and the calcium salts, the first acidification unit outputs CO₂.

19. The system of claim 17, further comprising a second acidification unit coupled to receive the aqueous HCl from the electrodialysis unit and the aqueous solution from the precipitation unit, wherein the second acidification unit is configured to be coupled to the power generator, and wherein in response to receiving the aqueous HCl and the aqueous solution the second acidification unit acidifies the aqueous solution.

20. The system of claim 17, further comprising a treatment unit coupled to receive the aqueous solution and output aqueous NaCl to the electrodialysis unit, wherein the aqueous solution includes seawater.

21. The system of claim 17, wherein the power generator is included in a power plant.
